(19) United States
(12) Patent Application Publication
(10) Pub. No.: US 2008/0152315 A1
(43) Pub. Date: Jun. 26, 2008

(54) Alternative Program Source Avoids Dvr Scheduling Conflict

(76) Inventors: Marc Andre Peters, Eindhoven (NL); Wilhelmus Henrica Gerarda Maria Van Den Boomen, Eindhoven (NL)

Correspondence Address: CORPORATE PATENT COUNSEL;Philips Electronics North America Corporation, P.O. Box 3001, Briarcliff Manor, NY, 10510, US

(21) Appl. No.: 10/561,997

(22) PCT Filed: Jun. 24, 2004
(86) PCT No.: PCT/IB04/50992

§ 371 Date: Dec. 23, 2005

(30) Foreign Application Priority Data
Jun. 27, 2003 (EP) 03101917.7

(51) Int. Cl. H04N 7/26

(52) U.S. Cl. 386/124

(57) ABSTRACT

A method is proposed to enable to automatically record a plurality of content programs that are listed for being broadcast. The method identifies alternative sources for supply of a specific one of the content programs; and conditionally selects a suitable one of the alternative sources for supply of the specific content program in order to avoid a scheduling conflict between recordings.

### FIELD OF THE INVENTION

The invention relates to, among other things, a digital video recorder (DVR) and to control software for being installed on a DVR. The invention also relates to an electronic program guide (EPG).

### BACKGROUND ART

DVRs, also referred to as personal video recorders (PVRs), are consumer electronics (CE) apparatus with a hard-disk drive (HDD) that enable the end-user to record TV broadcasts, e.g., for play-back at a later time or for time-shifting during a live broadcast. Programming a DVR is accomplished, for example as follows. The user indicates in an EPG what future broadcasts he/she would like to have recorded. The supporting EPG software then translates these indications into the scheduled start times and channels to control the DVRs recording functionality.

The TV-Anytime Forum is developing open specifications for interoperable and integrated systems to allow broadcasters and other service providers, CE manufacturers, content creators and telecommunications companies to maximize effective use of high-capacity digital storage in consumer devices. Metadata types defined by the TV-Anytime specifications include Content Description Metadata, which describes content, e.g., program title and synopsis. This kind of metadata is used in, e.g., an EPG or in Web pages to describe the content. Another type of metadata types defined by the specification includes Instance Description Metadata, used for linking content metadata to content. For the purpose of interoperability, the TV-Anytime Forum has adopted XML as the common representation format for metadata. The term “metadata” refers to descriptive data about content, such as program title and synopsis. This metadata allows consumers to find, navigate and manage content available from various sources. The metadata allows software agents to select content on the consumer's behalf.

One feature of the TV-Anytime specifications is content referencing. Content referencing provides the ability to map a unique pointer to a piece of content, such as a TV program, on a time and/or location (e.g., TV channel) where this piece of content can be acquired. The pointer is called a CRID (“content reference ID”). In the terminology of TV-Anytime, an organization that creates CRIDs is called an “authority”. There can be any number of authorities producing CRIDs, but each authority is uniquely identified by a name. The TV-Anytime standard uses the DNS name registration system to ensure that these names are unique. Each CRID has embedded the name of the authority that issued it, and there is accordingly a requirement for a means to take an authority name from a CRID, and find the server on the Internet where the CRID can be converted to a location.

The pointers comply with a syntax that enables to construct a hierarchy of pointers in order to manage the programs to which they refer, directly or indirectly. The TV-Anytime model allows certain grouping operations on the pointers (i.e., the CRIDs). One of the operations is the COLLECTION operation that clusters a set of pointers under a further pointer at a next higher level in the pointer hierarchy. Another operation is the ALTERNATIVE operation that splits a pointer in the pointer hierarchy into a plurality of pointers at a next lower level. See, e.g., IST-1999-11702 “myTV, deliverable #4, Progress in Standardization”, version 0.4, 30Sep. 2000, page 61.

More specifically, the TV-Anytime model allows an operation “record all” on the metadata as operands, in order to enable the end-user to automatically record a certain set of broadcasts that, e.g., the content provider or network operator or another third party has grouped together. The grouping is based, for example, on the programs having a common theme such as episodes of a particular series or on the programs forming an editorially coherent entity. Another operation is a “select” operation on the metadata for the purpose of recording a single program or a subset of programs selected from a larger set. These operations are controlled by means of the TV-Anytime metadata field “groupInformation” that contributes, together with other fields, to the resolving of the proper location (e.g., a scheduled broadcast time on a specific TV channel. This field is either set to COLLECTION, i.e., record all, or to ALTERNATIVE, i.e., select one from among many to record.

### SUMMARY OF THE INVENTION

The inventors have realized that content providers, broadcasters and network operators tend to make large groups, which in fact hampers the scheduling of recording requests as conflicts may arise with other recording requests scheduled.

For example, a first station broadcasting a series of programs on a first channel groups these programs using a first groupCRID with the meta tag set to COLLECTION. A second station broadcasting the same series on a second channel likewise groups the programs together using a second groupCRID and the meta tag set to COLLECTION. The CRID structure used by either will of course not refer to the other's broadcasts. Accordingly, programming the end-user's recorder to record the series under control of the meta data as provided by the broadcasting stations leads to recording the complete series either from the first channel or from the second channel, as there is no correlation between the two series at the recorder's control level. Later on, the recorder can be programmed to successfully record additional programs but under the constraint that these do not conflict with the time slots that are going to be occupied by the series as broadcast on the specific channel. Scheduling the successful recording of a group of programs that are going to be broadcast on a specific channel over a period of time therefore introduces some problems. A first problem is that the likelihood of a scheduling conflict increases with the number of recordings already scheduled. A second problem is that the exact broadcast times (or even days) are not known in advance for most programs. So, even if the user had worked around the recording of the series at scheduling additional recordings, the uncertainty about the exact times would very likely render this work moot. A third problem is that there is no easy solution available to the typical end-user other than staying alert and using a manual override in case of a conflict.

Assume now that an EPG service provider lists the series, as discussed above, in an EPG. Using the CRID approach, he/she assigns a super-groupCRID that refers to both broadcaster's groupCRIDs, the super-groupCRID having the meta tag set to ALTERNATIVE. This option merely leads to the problems discussed previously. In theory, another option for the service provider would be to create a new CRID per program, e.g., episode, with the meta tag set to ALTERNATIVE to account for the two channels, and couple all programs through a groupCRID set to COLLECTION. Clearly, this requires substantially more effort than merely creating a single super-groupCRID. Further, this second option needs maintenance as a new CRID, set to ALTERNATIVE, is to be made per new episode. Note that in the first option the service provider rides piggyback on the broadcasters as the latter keep their CRIDs up-to-date.

Within this context, the inventors propose a method of enabling to automatically record a plurality of content programs that are listed for being broadcast. The plurality of content programs comprises, for example, multiple episodes of a series. The method comprises enabling to identify alternative sources for supply of a specific one of the content programs. The method further comprises enabling to select a suitable one of the alternative sources for supply of the specific content program so as to comply with a predetermined condition. For example, the conditional selecting enables to minimize conflicts with one or more other content programs scheduled for being recorded. If the specific program and another program are going to be broadcast in a time-overlapping fashion, and the recorder cannot record two programs at the same time, then there is a scheduling conflict. It is helpful then to search for alternative sources that supply these programs in disjoint time slots. As another example, the conditional selecting enables to optimize the selection according to pre-determined user preferences as related to, e.g., language, subtitling, presence or absence of commercial breaks, image resolution as in digital TV, subscription fee or for free, etc. As yet another example, the conditional selection enables to postpone the recording of one or more programs by diversion to other sources in case the recorder's storage capacity available for recording is not sufficient or in case hardware resources are not available, being occupied for other purposes, etc. Above examples illustrate that problems may arise which justify the querying for alternative sources of one or more specific ones of the content programs to be recorded, in order to get the problem solved.

For clarity, programs supplied by different sources are the same for the purpose of the invention, if they are semantically substantially identical, independent of, e.g., subtitling, language, image resolution, insubstantial editing, etc. The expression “alternative sources” indicates those sources that supply the same specific content program, thus forming equivalent alternatives to choose from. The alternative sources comprise, e.g., one or more broadcast channels. In this case one or more EPGs are preferably used for identifying the alternative sources. Further, the alternative sources may comprise one or more recorders on a data network, e.g., a P2P network.

Preferably, selection of the source is dynamically updated as circumstances change. For example, a popular program scheduled for being recorded from a first channel is changed to recording from a second channel because of a conflict with another recording, and later on switched again to retrieval from a P2P network because of yet another conflict. User profile, popularity of a program, etc., may be taken into account to optimize the allocation of sources to record from, to programs marked for being recorded.

Above embodiments of the invention relate to, among other things, a service provided via, e.g., the Internet or any party upstream of the end-user, and enable following scenarios, given by way of example. The user's digital recorder or home network notifies the service of the programs intended for being recorded. The service then uses broadcast guides or other information to identify suitable sources of the programs that this particular user would like to have recorded so as to minimize local conflicts. In case of a scheduling conflict that cannot be resolved by means of re-scheduling, the service may record particular programs on behalf of this user and have them delivered to the user via, e.g., the Internet. Within this context, reference is made to International Application WO 2003032599 (attorney docket US 018166) briefly discussed further below. In another scenario, an EPG is provided that comprises, for a specific program from a specific source, a pointer to an equivalent program at an alternative source for selecting, e.g., manually by the user or automatically under software control, a proper one of the sources to minimize a conflict between scheduled recordings. For example, a user has programmed his/her recorder through interaction with the EPG. If the recorder's software detects a scheduling conflict, pointers to alternative sources are available to resolve the conflict by rescheduling the recordings using one or more other sources than the initial ones. Preferably, the user is notified of this re-scheduling.

A further embodiment relates to an electronic apparatus to control a recording of a plurality of content programs that are listed for being broadcast. The apparatus identifies alternative sources for supply of a specific one of the content programs. The apparatus selects a suitable one of the alternative sources for supply of the specific content program so as to comply with a predetermined condition, examples of which are as discussed above. The apparatus comprises, e.g., a digital recorder. Alternatively, the apparatus is a component on a home network with distributed functionalities, the apparatus being physically separate from the recorder. For example, the apparatus is Internet-enabled and can scan the Web for information on sources that supply the specific program, or can receive an EPG from a service provider.

Another embodiment relates to control software for being installed at a recorder or on the home network for control of the recorder to automatically record a plurality of content programs that are listed for being broadcast. The software enables to identify alternative sources for supply of a specific one of the content programs; and enables to select a suitable one of the alternative sources for supply of the specific content program so as to comply with a predetermined condition, examples of which are given above.

### BRIEF DESCRIPTION OF THE DRAWING

The invention is explained in further detail, by way of example and with reference to the accompanying drawing wherein:

FIGS. 1 and 2 are diagrams illustrating programming operations and operands; and

FIG. 3 is a block diagram illustrating software aspects of a DVR. Throughout the figures, same reference numerals indicate similar or corresponding features.

### DETAILED EMBODIMENTS

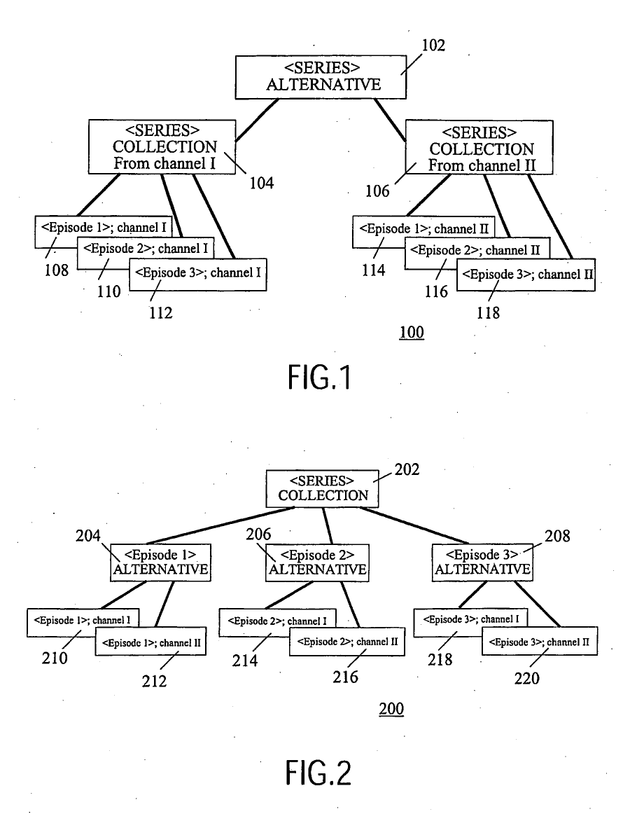

FIG. 1 illustrates a configuration 100 of operations in order to enable to automatically record a plurality of content programs, here a TV broadcast series, from multiple sources, here a TV channel I and a TV channel II, each broadcasting the series independently. In the example, the series comprises episodes 1, 2 and 3. Each channel is associated with a respective supplier, e.g., a TV station. Metadata obtained, e.g., via an EPG, enables to identify each respective one of the episodes and for each respective episode the associated channels and broadcast times. In a TV-Anytime (see above) scenario, content and its source are identified through the metadata referred to as “a CRID” (see above), the syntax of which is prescribed, but whose various constituents are determined by, e.g., the content provider.

The metadata descriptive of the scheduled broadcast enables to carry out certain operations at the end-user's DVR. The TV-Anytime model, for example, allows an operation “record all”, on the metadata as operands in order to enable to record a certain set of broadcasts, e.g., TV programs that the content provider (e.g., a broadcast station) has linked because of a common theme such as is the case with all episodes of a particular series. Another suitable TV-Anytime operation is a “select” operation on the metadata for the purpose of recording a single program selected from a plurality of alternatives. These operations are controlled by means of the metadata field “groupInformation” that contributes, together with other fields, to the resolving of the proper location (e.g., scheduled TV channel). This field is either set to COLLECTION, i.e., record all, or to ALTERNATIVE, i.e., select one from among many to record.

In configuration 100, the content provider has combined the control information for a specific TV series on channel I with the control information for the same TV series on channel II as follows. The user is provided, e.g., via an EPG, another third-party service or website, with information about this specific TV series. Also, metadata for control of the user's DVR is provided with the option, in a block 102, to have his/her DVR programmed through a suitable user-interface to either record the series from channel I in a block 104 or from channel II in a block 106. The metadata is received, e.g., via a DVB stream, or via the EPG requests submitted to a server (as with the server of the BBC), or via another data service on the Internet. The metadata is locally stored. When the DVR is programmed to record a certain program, the relevant metadata is retrieved from local storage. Alternatively, or in addition, further metadata can be requested from the service provider. If the user selects the recording being made from, e.g., channel I, the DVR will automatically configure itself under control of the metadata, in block 104, to record episodes 1, 2 and 3, and possibly more episodes in an open-ended series, from channel I as indicated in blocks 108, 110 and 112, respectively. Now imagine that the user has already scheduled the recording of a further program that turns out to conflict with the broadcast of episode 3 on channel I in block 112 or with another episode in the open-ended series. Then the request for recording of the relevant episode will fail, unless the user manually corrects the recording schedule, thereby overriding the processing of the metadata associated with the series and as a result rendering the programming procedure through the metadata less useful.

FIG. 2 illustrates a configuration 200 that uses the COLLECTION and ALTERNATIVE options in a more efficient manner in order to reduce the chance on a conflict of the type discussed above. This approach is based on moving the ALTERNATIVE option further down in the decision-tree to a level of finer granularity, which turns out to result in a more robust programming. In configuration 200, the user is provided with the option 202 to program the DVR so as to record all episodes, as indicated in blocks 204, 206 and 208, in such a manner that the DVR decides to record each specific one of episodes 1, 2 and 3 either from channel I or from channel II, as indicated in blocks 210, 212; 214, 216; and 218, 220. The choice to record a specific episode from a specific channel is made dependent on one or more predetermined conditions. For example, the DVR is programmed to record episode 1 from channel I by default, as in block 210. However, in case of a scheduling conflict with a further program to be recorded, the DVR chooses to record episode 1 from channel II as in block 212. A conflict occurs if, e.g., the further program to be recorded is being broadcast at the time channel I airs episode 1 and DVR has only a single tuner available for recording.

In an embodiment of the invention, the user's DVR or another component on the user's home network receives program information in the format of configuration 100 discussed above. The DVR or the other component newly creates local identifiers of the content programs based on the programs' original identifiers as used in configuration 100. Possibly, metadata other than the identifiers is taken into account as well, such as title, episode number or synopsis. The newly created local identifiers are linked to the original identifiers in configuration 100 but impose configuration 200 on the DVR. More specifically, the DVR has to find out which pointer of block 104 corresponds with which pointer in block 106. That is, the DVR has to determine that the content of block 108 (episode 1 at channel I) is equivalent to the content of block 114 (episode 1 at channel II). Most conveniently, this is accomplished under software control by means of considering additional metadata, such as title and episode number.

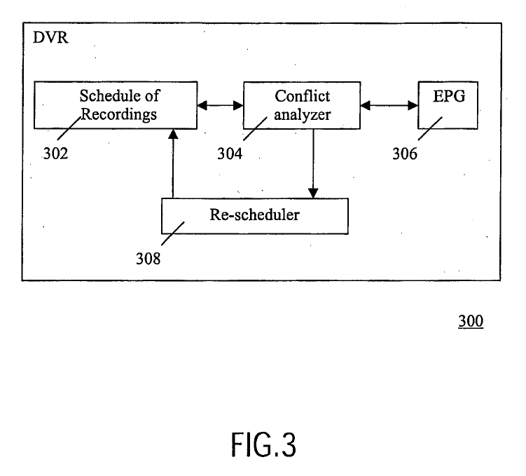

FIG. 3 is a block diagram illustrating software functionalities of a DVR 300 in the invention. DVR 300 comprises a list 302 that represents the schedule of programs to be recorded. DVR 300 further comprises a conflict analyzer 304 that analyzes list 302 in order to detect conflicts, e.g., two different programs have been scheduled to be recorded that are going to be broadcast in a time-overlap. DVR 300 has only a single tuner available for recording, so there is a scheduling conflict. Analyzer 304 then consults an EPG 306 to find whether any of the programs can be obtained from another channel. EPG 306 is a conventional EPG, or an EPG that comprises, for a specific program from a specific source, a pointer to an equivalent program at an alternative source. This facilitates selecting a proper one of the sources to minimize a conflict between scheduled recordings. As yet another option, EPG 306 is comprises in an electronic content guide (ECG) as disclosed in WO0186948, further discussed below. If both programs can be obtained from other channels so that there is no time overlap between their broadcasts, analyzer 304 checks if selecting another channel for a specific one of the two programs causes other conflicts. If there are no conflicts, the recording of the specific program is re-scheduled through a re-scheduler 308 to be recorded from the other channel. If there is a conflict, analyzer 304 checks if re-scheduling the other program causes conflicts. If there are no conflicts, the other program is re-scheduled. If conflicts arise due to rescheduling of already conflicting programs, a more extensive search for an optimum schedule may be necessary, possibly under constraints imposed by user-preferences.

Incorporated by reference herein:

U.S. Ser. No. 09/519,546 (attorney docket US 000014) filed Mar. 6, 2000 for Erik Ekkel et al., for PERSONALIZING CE EQUIPMENT CONFIGURATION AT SERVER VIA WEB-ENABLED DEVICE, published under PCT as International Application WO0154406. This document relates to facilitating the configuring of consumer electronics 30′ (CE) equipment by the consumer by means of delegating the configuring to an application server on the Internet. The consumer enters his/her preferences in a specific interactive Web page through a suitable user-interface of an Internet-enabled device, such as a PC or set-top box or digital cellphone. The application server generates the control data based on the preferences entered and downloads the control data to the CE equipment itself or to the Internet-enabled device.

U.S. Ser. No. 09/568,932 (attorney docket US 000106) filed May 11, 2000 for Eugene Shteyn and Ruud Roth for ELECTRONIC CONTENT GUIDE RENDERS CONTENT RESOURCES TRANSPARENT, published under PCT as International Application WO0186948. This document relates to a data management system on a (home) network that collects data that is descriptive of content information available at various sources on the network. The data is combined in a single menu to enable the user to select from the content, regardless of the source.

U.S. Ser. No. 09/971,474 (attorney docket US 018166) filed Oct. 4, 2001 for Eugene Shteyn and Jean Moonen for DIGITAL CONTENT CATERING, published under PCT as International Application WO2003032599. This document relates to catering of electronic content information via a network. A consumer is enabled to request delivery via the network of a specific piece of content before a deadline selectable by the consumer. The catering service then completes the delivery before the deadline under control of a bandwidth profile of data traffic on at least a segment of the network. The scheduling of delivery deadline enables the service to optimize usage of the network's bandwidth while maintaining a quality of service.

1. A method of enabling to automatically record a plurality of content programs that are listed for being broadcast, the method comprising:
enabling to identify alternative sources for supply of a specific one of the content programs; and
enabling to select a suitable one of the alternative sources for supply of the specific content program so as to comply with a predetermined condition.

2. The method of claim 1, wherein the condition relates to minimizing a conflict with another one of the content programs scheduled for being recorded.

3. The method of claim 1, wherein the condition relates to optimizing the selecting according to a pre-determined user preference.

4. The method of claim 1, wherein at least one of the alternative sources comprises a broadcast channel.

5. The method of claim 4, comprising enabling to use an EPG for identifying the alternative sources.

6. The method of claim 1, wherein at least one of the alternative sources comprises a recorder on a data network.

7. The method of claim 1, wherein the plurality of content programs comprise multiple episodes of a series.

8. The method of claim 1, comprising dynamically updating the selecting of the suitable source.

9. An electronic apparatus operative to control a recording of a plurality of content programs that are listed for being broadcast, the apparatus being further operative to identify alternative sources for supply of a specific one of the content programs and to select a suitable one of the alternative sources for supply of the specific content program so as to comply with a predetermined condition.

10. The apparatus of claim 9, wherein the condition relates to minimizing a conflict with another one of the content programs scheduled for being recorded.

11. The apparatus of claim 9, wherein the condition relates to optimizing the selection according to a pre-determined user preference.

12. The apparatus of claim 9, wherein at least one of the alternative sources comprises a broadcast channel, the apparatus having access to an EPG for identifying at least a sub-set of the alternative sources.

13. The apparatus of claim 9, comprising a digital recorder.

14. The apparatus of claim 9, having a connection for connecting to a data network.

15. Software for being installed at a controller for control of a recorder for recording a plurality of content programs listed for being broadcast, the software being operative to identify alternative sources for supply of a specific one of the content programs; and to select a suitable one of the alternative sources for supply of the specific content program so as to comply with a predetermined condition.

16. The software of claim 15, wherein the condition relates to minimizing a conflict with another one of the content programs scheduled for being recorded.

17. The software of claim 15, wherein the condition is operative to make the selection according to a pre-determined user preference.

18. An EPG comprising, for a specific program from a specific source, a pointer to an equivalent program at an alternative source for enabling to select a proper one of the sources to minimize a conflict between scheduled recordings.
